(19) United States
(12) Patent Application Publication
(10) Pub. No.: US 2004/0242139 A1
(43) Pub. Date: Dec. 2, 2004

(54) Utensil for peeling crustacean shell

(76) Inventors: Gregory Joseph Carty, Coffs Harbour (AU); John Duncan Waldron, Toormina (AU); Alan Jenkinson, Coffs Harbour (AU)

Correspondence Address: SALTAMAR INNOVATIONS, 30 FERN LANE, SOUTH PORTLAND, ME, 04106, US

(21) Appl. No.: 10/482,633

(22) PCT Filed: Jun. 28, 2002
(86) PCT No.: PCT/AU02/00842

(30) Foreign Application Priority Data
Jun. 28, 2001 (AU) PR5962

(51) Int. Cl. A22C 29/02

(52) U.S. Cl. 452/6

(57) ABSTRACT

A utensil (1) for removing the shell from the body of a crustacean prior to consumption. The utensil comprises of a body (2) having a leading end (2) and a trailing end (4), the leading end (3) includes a leading end tip (5) capable of engaging the crustacean between an underside of a shell and opposing body surface of the crustacean. The leading end comprises of contoured portions (6,7) co-operate with the leading end tip (3) to lift and separate said shell from said crustacean body. The trailing end (4) comprises of a handle which allows a user to urge the utensil (1) longitudinally of the body (2) so the shell is separated in one pass along spine.

### BACKGROUND OF THE INVENTION

The invention relates to hand utensils and more particularly relates to a hand utensil for use in preparation including shelling of marine crustaceans, such as prawns, shrimp and crayfish, for consumption. More particularly, the invention relates to a utensil which enables separation of a crustacean shell from a crustacean body.

### PRIOR ART

Many attempts have been made over the past century or more, to create a simple, functional hand tool to aid in the preparation for consumption of prawns, crustaceans and the like. Such crustaceans require the head, shell and sand vein to be removed before they can be eaten. Carried out manually, this is potentially a slow, messy and tricky process. Shelling uncooked prawns is an even more difficult process requiring separation of the shell from the body.

There are a variety of known utensil designs adapted for the task of shelling and deveining such crustaceans as shrimps, prawns and the like. Generally the known devices do not possess a geometry in a single utensil which enables convenient and efficient separation of shell and sand vein from the body of the crustacean across the full contact shell/body interface.

U.S. Pat. No. 4,553,287 describes a tool that possesses a narrow, curved and tapered prong that is inserted into a deheaded prawn. As the prong is pushed further inside the shell, the shell is lifted and split, and a skewed ridge on the underside of the prong dislodges the sand vein.

U.S. Pat. No. 4,048,696 describes a narrow, cranked rod, which both lifts the shell and cuts through the top of it, as the tool is forced into the shell. The rod may also have a serrated lower edge to enable removal of the vein.

Other variant forms have been designed, each one with its own shortcomings, by virtue of inadequacy or inefficiency of function, or requiring a multiplicity of components.

### INVENTION

The present invention seeks to overcome the shortcomings of the prior art by providing an improved hand held utensil of unitary construction for manually and concurrently peeling and deveining prawns, crustaceans and the like. According to one embodiment, the handle of the tool is held in the palm of the hand, while a leading end of the utensil includes a leading edge tip and a (lateral) contoured region. The utensil is inserted into a deheaded prawn and as the leading edge ( curved) tip is pushed down the spine of the prawn, the shell is separated on the underside which opposes the spine and spread outwards by the contoured region disposed on the utensil between the tip and handle. A small blade behind the leading edge tip of the tool opens the membrane covering the vein, allowing easy removal of the vein by hand.

In one broad form the present invention comprises:

a utensil for removing the shell from the body of a crustacean prior to consumption;

the utensil comprising;

a utensil body having a leading end and a trailing end;

wherein the leading end includes a leading edge tip capable of engaging the crustacean between an underside of a shell and opposing body surface of the crustacean;

the leading end further comprising contoured portions which co operate with the leading edge tip to lift and separate said shell from said crustacean body;

the trailing end comprising a handle which allows a user to urge the utensil longitudinally of the body so the shell is separated in one pass along spine. According to a preferred embodiment, the contoured portions of the utensil are symmetrical about a longitudinal axis of the utensil.

Preferably the contours each include a decline portion and an incline towards the trailing end and together form a wall which defines a recess which receives a sand vein during peeling. According to one embodiment, the leading edge comprises a taper from a first narrow region at the leading tip of the utensil to a wider taper terminating at said inclines. According to one embodiment, the recess defined by said inclined and decline portions communicates with a longitudinal recess in the utensil which extends at least part way along said handle. Preferably the recess defined by the wall is substantially U shaped or circular when viewed in cross section. The leading tip includes an upper surface which includes a relief extending therefrom which contributes to the separation between the shell and body of the crustacean.

According to one embodiment the leading end tip has a radius of curvature in a vertical plane.

In another broad form the present invention comprises:

a utensil for removing the shell from the body of a crustacean prior to consumption of the body, the utensil comprising;

a utensil body having a leading end and a trailing end;

wherein the leading end includes a pointed leading edge tip capable of engaging the crustacean between an underside of a shell and opposing body surface of the crustacean;

the leading end further comprising; a taper in which the tip increases in width in the direction of the trailing end and contoured portions which co operate with the leading edge tip to lift and separate said shell from said crustacean body;

the trailing end comprising a handle which allows a user to urge the utensil longitudinally of the body so the shell is separated in one pass along spine.

In another broadest form the present invention comprises:

a hand operated utensil for peeling the shell from a crustacean body such as a prawn, shrimp or the like; the utensil having a leading end geometry which allows separation of the shell from the body, and a handle at a trailing end; wherein the leading end includes a tapered tip which increases in width in the direction of the trailing end and adjacent lateral contours which define a recess in the utensil; the contours including a first inclined region which co operates with the leading end tip to separate in one pass the shell from the body of the crustacean.

In one broad form of the method aspect the present invention comprises:

a method of manufacturing a utensil for removing the shell from a crustacean; the method comprising the steps of;

introducing a plastics material into a mould having a configuration which produces a utensil which comprises;

a utensil body having a leading end and a trailing end;

wherein the leading end includes a leading edge tip capable of engaging the crustacean between an underside of a shell and opposing body surface of the crustacean;

the leading end further comprising contoured portions which co operate with the leading end tip to lift and separate said shell from said crustacean body;

the trailing end comprising a handle which allows a user to urge the utensil longitudinally of the body so the shell is able to be separated in one pass along the back of the crustacean.

In another broad form the method aspect the present invention comprises;

a method of manufacturing a utensil for removing the shell from a crustacean; the method comprising the steps of;

a) taking a sheet of metal;

b) working the metal sheet to form a utensil comprising;

a utensil body having a leading end and a trailing end;

wherein the leading end includes a leading edge tip capable of engaging the crustacean between an underside of a shell and opposing body surface of the crustacean;

the leading end further comprising contoured portions which co operate with the leading end tip to lift and separate said shell from said crustacean body;

the trailing end comprising a handle which allows a user to urge the utensil longitudinally of the body so the shell is able to be separated in one pass along the back of the crustacean; the handle including edge returns which provide strengthening ribs for the handle.

### DESCRIPTION OF THE DRAWINGS

The present invention will now be described in more detail according to preferred but non limiting embodiments and with reference to the accompanying illustrations. Wherein;

FIG. 1 shows an underside view perspective of the of the utensil according to a preferred embodiment.

FIG. 2 shows the utensil of FIG. 1, with the blade on the end of the handle absent.

FIG. 3 shows an underside view perspective of the of the utensil according to an alternative embodiment with a recess along the full length of the utensil and trailing edge blade.

FIG. 4 shows the utensil of FIG. 3, with no blade on the end of the handle.

FIG. 5 shows an alternative embodiment of the utensil with no trough in the handle.

FIG. 6 shows the utensil of FIG. 5 with no bottle opener.

FIG. 7 shows a utensil according to an alternative embodiment with blade absent on the end of the handle.

FIG. 8 shows a section through A-A′, in FIG. 1 taken across the area behind the deveining blade, and between the contoured wings.

FIG. 9 shows a section through B-B′ in FIG. 1 24, showing the profile of the deveining blade.

FIG. 10 shows an enlarged view of the leading edge and deveining blade.

FIG. 11 shows a plan view of the underside of the peeler, showing all features present in FIG. 1.

FIG. 12 shows a plan view of the underside of the peeler, showing all features present in FIG. 2.

FIG. 13 shows a plan view of the underside of the peeler, showing all features present in FIG. 3.

FIG. 14 shows a plan view of the underside of the peeler, showing all features present in FIG. 4.

FIG. 15 shows a plan view of the underside of the peeler, showing all features present in FIG. 5.

FIG. 16 shows a plan view of the top of the peeler, showing just the general outline of the peeler.

FIG. 17 shows a side elevation view of the peeler, relating to the features present in FIG. 1.

FIG. 18 shows a side elevation view of the peeler, relating to the features present in FIG. 2.

FIG. 19 shows a side elevation view of the peeler, relating to the features present in FIG. 3.

FIG. 20 shows a side elevation view of the peeler, of FIGS. 4 & 7.

FIG. 21 shows an enlarged side elevation view of the nose of the peeler, showing the notched deveining blade.

FIG. 22 shows the view of FIG. 21 with the notch in the deveining blade absent.

FIG. 23 shows the leading end of the utensil engaging a shrimp with head removed.

FIG. 24 shows a plan view of FIG. 1.

FIG. 25 shows a side view of FIG. 24.

FIG. 26 shows an underside elevation of a peeler manufactured from metal according to an alternative embodiment.

FIG. 27 shows a side elevation of the peeler of FIG. 26

FIG. 28 shows a leading end view of the peeler of FIG. 26

FIG. 29 shows a trailing end of the peeler of FIG. 26.

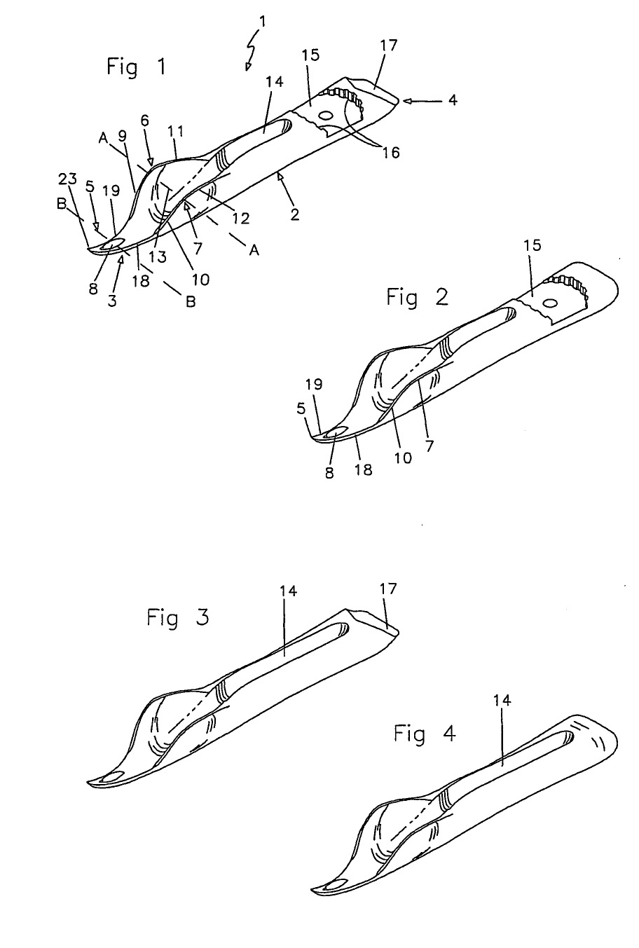

Referring to FIG. 1 there is shown an underside perspective view of a peeler 1 according to a preferred embodiment. Peeler 1 comprises a body 2 having leading end 3 and trailing end 4. Leading end 3 comprises a tapered nose 5 and winged contours 6 and 7. Tapered nose 5 includes a relief which provides a divining blade 8. Nose 5 preferably is arcuate to enhance initial separation of a shell as the leading end engages between a shrimp body and the shell. Winged contours 6 and 7 are preferably symmetrical about a longitudinal axis of peeler 1 and each comprise descending edges 9 and 10 which terminate in ascending edges 11 and 12. Edges 9 and 10 divide lateral shell segments from the shrimp body and laterally displace those segments. Contours 6, 7 and 11, 12 define a recess 13 receives the shrimp body during shell separation. Recess 13 extends longitudinally along body 2 of peeler 1 and communicates with longitudinal channel 14. Peeler 1 further comprises optional bottle opening recess 15 which is partially defined by serrations 16 which are capable of engaging corresponding serrations on a bottle top not shown. Body 2 is also adapted with optional cutting blade 17. The region of body 2 rearward of leading end contours 11 and 12 functions as a handle for operating the peeler. FIG. 1 shows the general form of the tool, being moulded in one piece from a suitable plastic or stainless steel, and having a preferred length in the region of 160 mm. The tool has essentially three sections, according to function: the leading end nose, the contoured wings and the handle. In use, the tool is held firmly by the handle, with the nose curving downwards. The nose is tapered, with a curved blade on its underside to facilitate deveining.

FIG. 2 shows the utensil peeler configuration of FIG. 1 with corresponding numbering and with the blade 17 removed from the handle.

FIG. 3 shows the peeler 1 according to an alternative embodiment with no bottle opener in the handle. Recess 14 has been extended to almost the full length of the handle.

FIG. 4 shows the peeler configuration of FIG. 3 with cutting blade 17 removed.

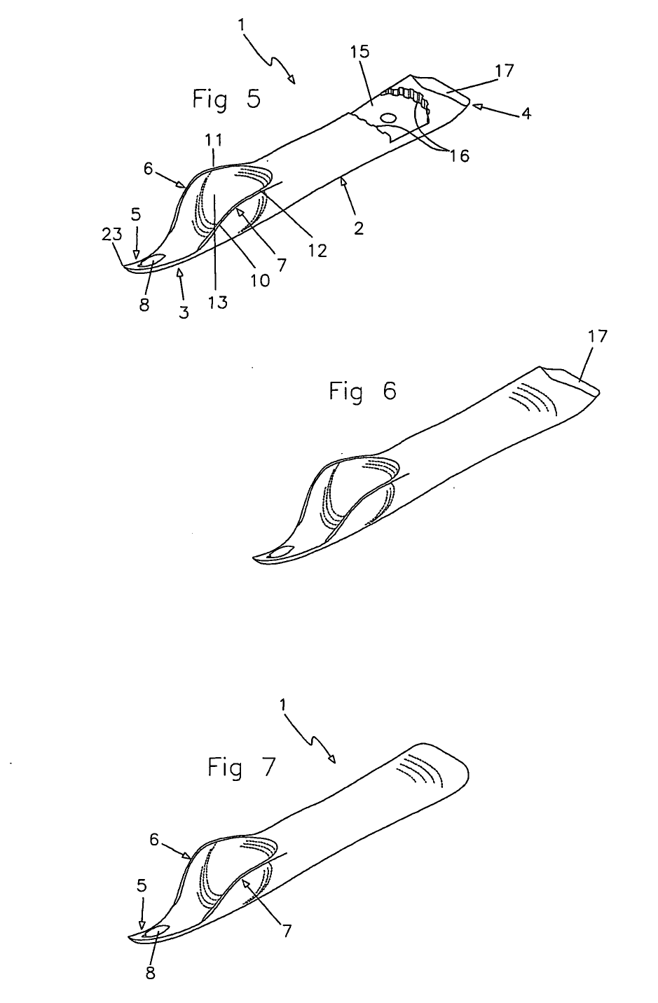

FIG. 5 shows the peeler of FIG. 4 with longitudinal recess 14 removed.

FIG. 6 shows the peeler of FIG. 5 with bottle opening recess 15 removed but retaining cutting blade 17.

FIG. 7 shows an alternative arrangement of peeler 1 with no additional utility features on the handle of body 2. This is the simplest form of a peeler but retains the leading end configuration comprising nose 5, deveining blade 8 and winged contours 6 and 7 as described for FIG. 1.

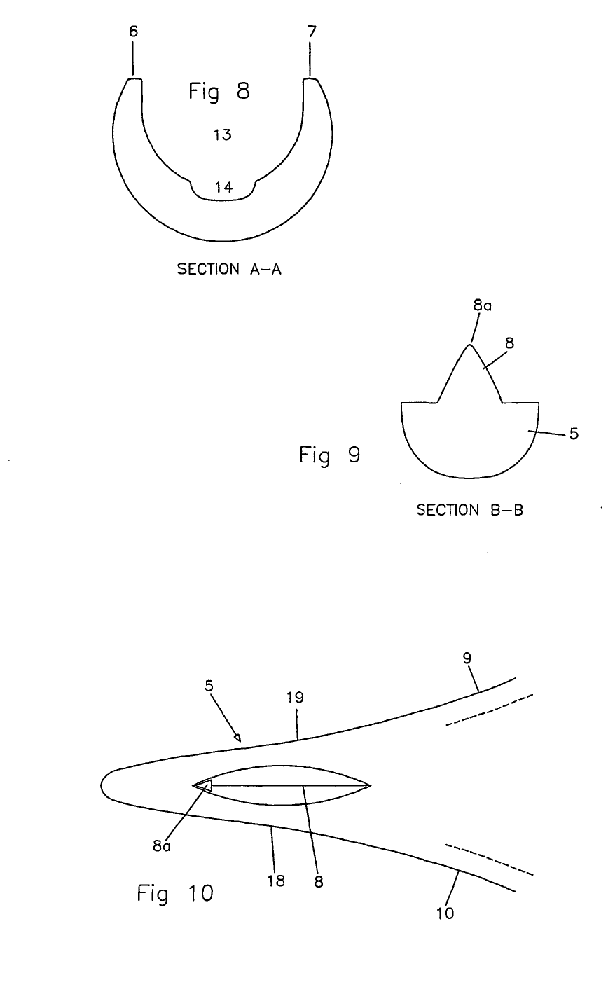

FIG. 8 is a section through A-A of FIG. 1 showing winged contours 6 and 7 behind the deveining blade 8 and which have a substantially spherical outer surface 18. Inner surfaces 6a and 7a define recess 13 whose bottom is defined by elongated recess 14.

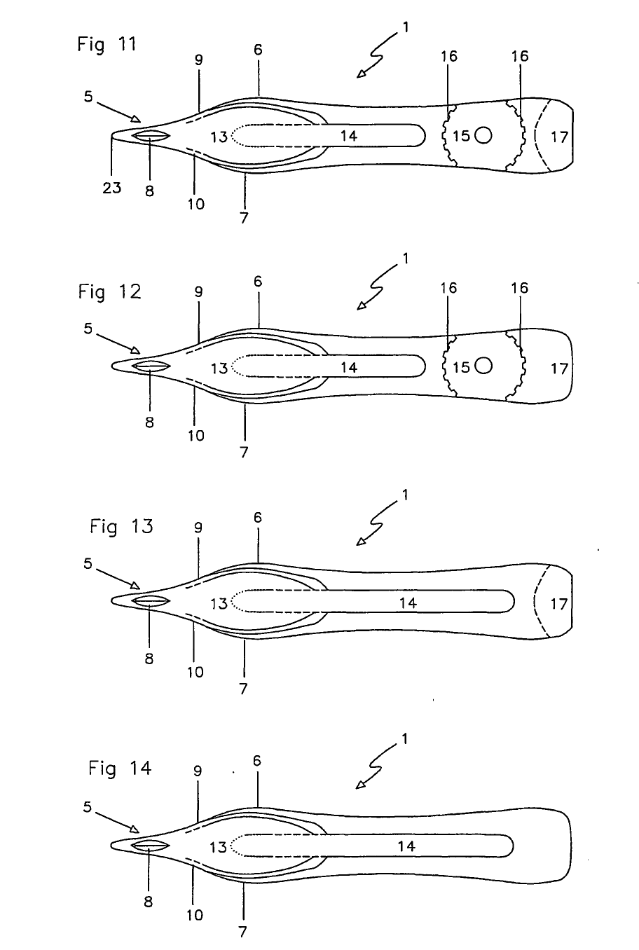

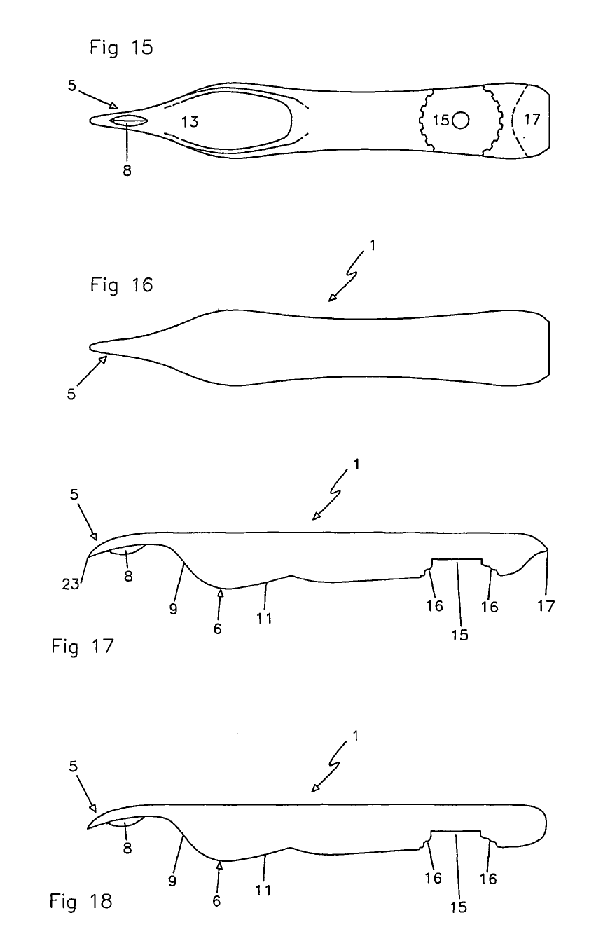

FIG. 9 is a section through B-B′ in FIG. 1, showing the profile of the deveining blade 8. Deveining blade 8 is preferably triangular and includes apex 8a which facilitates deveining. FIG. 10 shows an enlarged view of leading end 3 comprising edges 18 and 19 of nose 5 and edges 9 and 10. FIG. 11 is a plan view of the underside of the peeler, showing all features present in FIG. 1. FIG. 12 is a plan view of the underside of the peeler, showing all features present in FIG. 2. FIG. 13 is a plan view of the underside of the peeler, showing all features present in FIG. 3. FIG. 14 is a plan view of the underside of the peeler, showing all features present in FIG. 4. FIG. 15 is a plan view of the underside of the peeler, showing all features present in FIG. 5. Plan views relating to FIGS. 6 & 7 are not shown, but their features may be inferred from the preceding illustrations.

FIG. 16 is a top plan view of peeler 1, showing a preferred peripheral contour of the peeler.

FIG. 17 is a side elevation view of the peeler, incorporating the features of the embodiment of FIG. 1.

FIG. 18 is a side elevation view of the peeler, incorporating the features of the embodiment of FIG. 2.

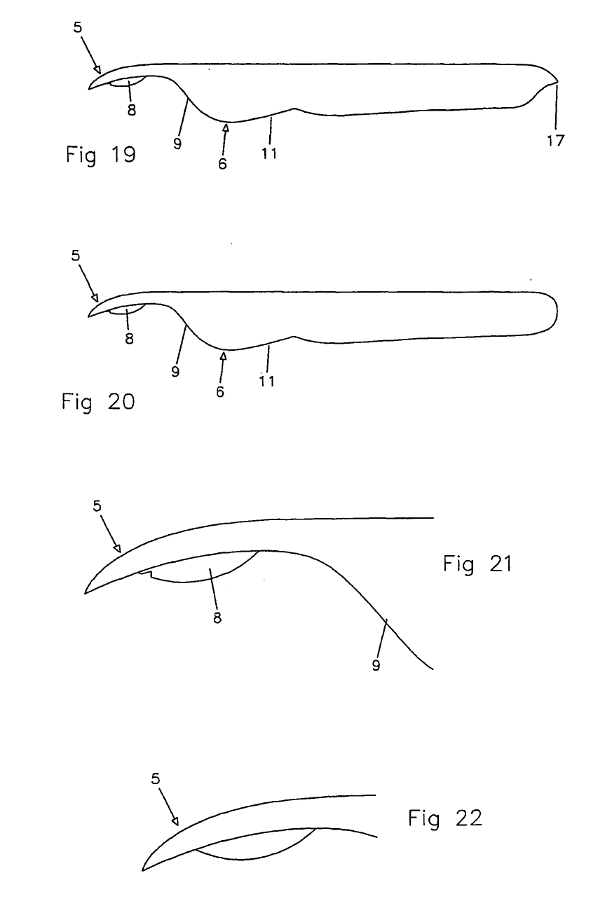

FIG. 19 is a side elevation view of the peeler, incorporating the features of the embodiment of FIG. 3.

FIG. 20 is a side elevation view of the peeler, incorporating the features of the embodiment of FIGS. 4 & 7.

FIG. 21 shows an enlarged side elevation view of the nose of the peeler, showing a notch 8b in deveining blade 8.

FIG. 22 shows is an enlarged side elevation view of the nose of the peeler but with notch 8b removed from the deveining blade 8.

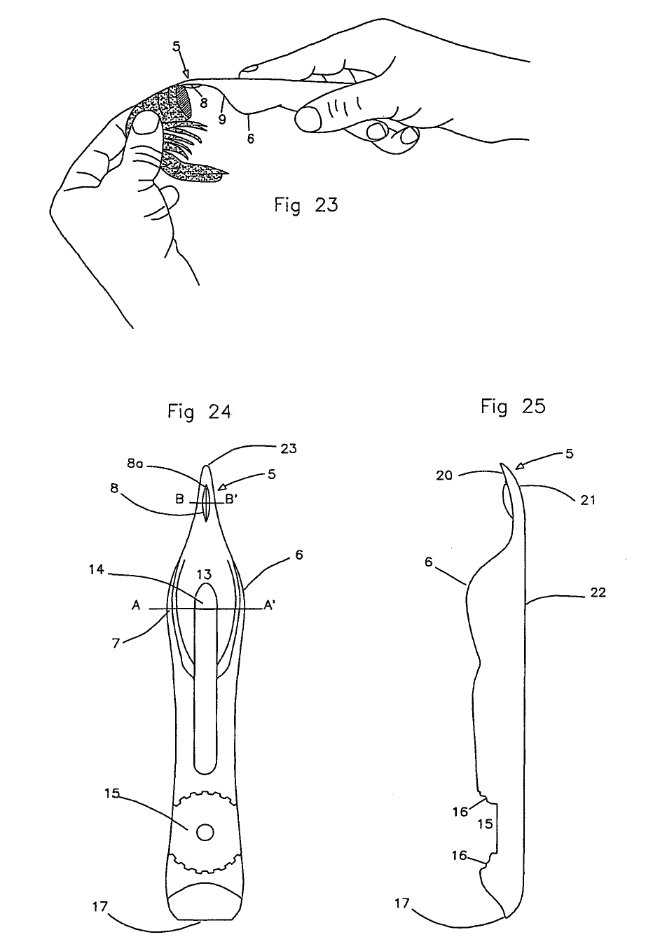

FIG. 23 shows a typical peeler in use. As can be seen the use holds the crustacean with one hand the peeler in the other hand. Leading tip or nose 5 is introduced between an inner surface of a shell and an upper surface of the body of the crustacean. The peeler is advanced longitudinally along the back of the body until leading edge of winged contour engages lateral shell walls. The combined action of the nose 5 and contours 6 and 7 effect removal of the shell as the peeler advance along the body. In use, after deheading the prawn, the curved nose/tapered end 5 is pushed into an open end of the shell, between the flesh and the top of the shell, while holding the tail of the prawn. The peeler is gradually pushed further into the shell forcing the shell to spread apart over the wings of the peeler, splitting on the underside. At the same time, the blade 8 on the underside of the nose 5 cuts the membrane over the sand vein, allowing easy removal of the vein afterwards. When the peeler has been pushed all the way to the end of the tail, the flesh can be lifted out in one piece.

FIG. 24 shows a plan view of FIG. 1 and FIG. 25 shows a side view of FIG. 24. As shown in FIGS. 24 & 25, the nose 5 increases in width of taper from the rounded tip 23 to the wings 6 and 7. The edges 18 and 19 of the wide section of the nose 5 are angled at around 10 and 20 degrees respectively, to the longitudinal centre line. The radius of curvature is continuous. At the base of nose 5, approximately 28 mm from the tip, the contoured wings 6 and 7 develop, sweeping backwards and downwards, with the leading edges angled at approximately 50 degrees to the longitudinal centre line, when viewed from the side; their thickness is approximately 3 mm at maximum.

Wings 6 and 7 gradually diminish backwards to approximately 68 mm from the tip of the nose, until they merge with the handle; the trailing edges are angled at approximately 15 degrees to the longitudinal centre line, when viewed from the side, also converging slightly when viewed from below.

The radius of curvature of the underside 20 of the nose 5 is preferably approximately 85 mm, varying between 60 mm and 120 mm. The radius of curvature of a convex side 21 of nose 5 is preferably approximately 30 mm on average, varying upwards from approximately 5 mm. The deveining blade 8 below the nose preferably has a radius of curvature of 12 mm, and protrudes 2.7 mm below the underside surface 20 of the nose. Handle itself 12 may be shaped appropriately to fit the hand but is generally of a slightly tapered form, front to rear, the taper angle being approximately 3.5 degrees.

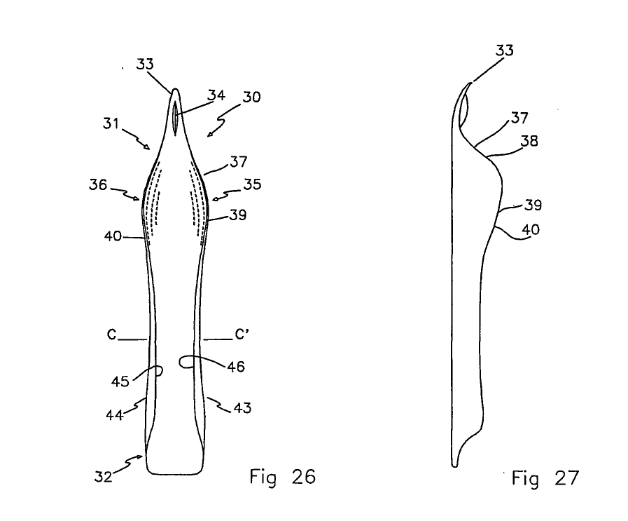

FIG. 26 shows an underside elevation of a peeler 30 manufactured from metal according to an alternative embodiment. Whereas the peeler 1 of FIG. 1 is preferably manufactured from a mould peeler 30 is formed using conventional metal forming techniques. Peeler 30 is preferably formed from a piece of flat metal and has a leading end 31 and tailing end 32. Leading end 31 substantially the same configuration of leading end 3 of the peeler of FIG. 1 and includes tapered nose 33 and deveining blade 34. Leading end 31 includes winged contours 35 and 36 which are formed by introducing an arcuate formation in the metal plate from which peeler 30 is formed. Tapered nose 33 includes a relief which forms divining blade 34. Preferably, nose 33 is when the peeler is in use, concave upward to enhance initial separation of a shell as the leading end engages between a shrimp body and the shell. Winged contours 35 and 36 are preferably symmetrical about a longitudinal axis of peeler 30 and each comprise descending edges 37 and 38 which terminate in ascending edges 39 and 40. Edges 37 and 38 divide lateral shell segments from the shrimp body and laterally displace those segments. Winged contours 35 and 36 define a recess 41 which receives the shrimp body during shell separation. Recess 41 extends longitudinally along peeler 30 and communicates with longitudinal recess 42 defined by strengthening ribs 43 and 44 formed by returning edges 45 and 46.

FIG. 27 shows a side elevation of the peeler of FIG. 26

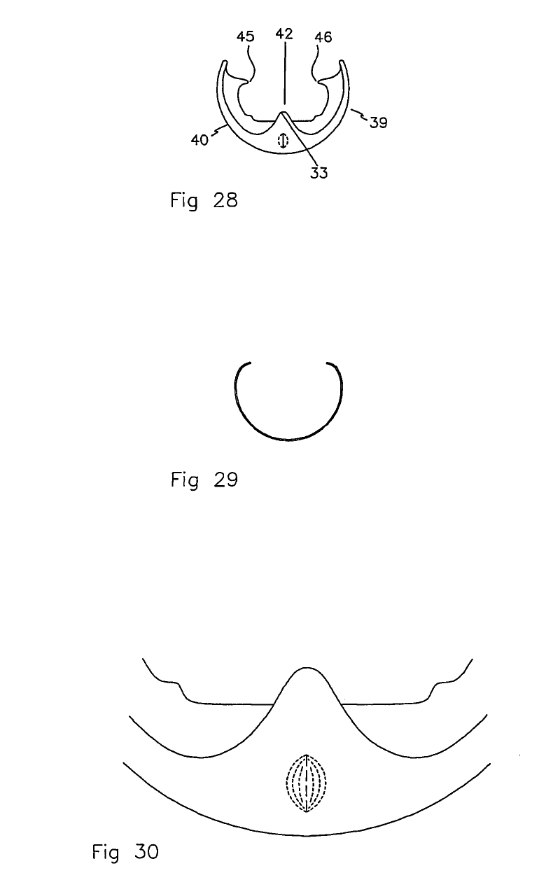

FIG. 28 shows a leading end view of the peeler of FIG. 26

FIG. 29 shows a trailing end of the peeler of FIG. 26

In a first embodiment as shown in FIGS. 1, 11, 17 and 24, the tool features a cutting edge 17 on the end of the handle and a trough 14 recessed into the underside of the handle, 7 mm wide, 65 mm long, and approximately 10 mm deep. A twist-top bottle opener 15 is also included, recessed into the handle. This recess is not wholly within the edges of the handle, allowing for finger contact, to aid gripping the twist-top. The bottle opener may be present as either an indentation in the handle or a separate component incorporated into the handle during the moulding process. The base of trough recess 14 is parallel to the straight top edge of the handle and the rear end of the trough is approximately 50 mm from the end of the handle.

A second alternative embodiment, in FIGS. 2, 12 & 18, the cutting edge on the end of the handle is omitted. This non essential edge is provided to facilitate easy removal of the head of the prawn.

A third alternative embodiment as shown in FIGS. 3, 13 and 19, the bottle opener is omitted but retains the cutting edge 17 on the handle.

A fourth alternative embodiment, in FIGS. 4, 14 and 20, omits both bottle opener and cutting edge on the handle.

Fifth, sixth and seventh alternative embodiments are presented in FIGS. 5-7 and 15, these being essentially similar to embodiments 2, 3 and 4, but omitting the trough in the handle. The trough is incorporated as an aid to fast manufacture when moulding in plastic, but its removal will not affect the function of the peeler.

The blade 8 below the nose 5 (see FIGS. 10 and 21) is primarily in the form of a curved, vertically tapered projection with an optional notch 8a in the leading edge. The notch serves to improve the membrane cutting function, but is not essential. It can be seen in FIGS. 2, 10 and 21 that the notch is placed forward of the bottom edge of the blade 8, minimising any risk of rupturing the vein, as may happen with a fully serrated blade.

It will be recognised by persons skilled in the art that numerous variations and modifications may be made to the invention broadly described herein without departing from the overall spirit and scope of the invention.

1-35. (Canceled).

36. A utensil for removing the shell from the body of a crustacean prior to consumption; the utensil comprising;
a utensil body having a leading end and a trailing end;
wherein the leading end includes a leading edge tip capable of engaging the crustacean between an underside of a shell and opposing body surface of the crustacean;
the leading end further comprising contoured portions which together form a wall which defines a recess in the utensil and co operate with the leading end tip to lift and separate said shell from said crustacean body; wherein the wall formed by the contours is abbreviated to form said leading end tip;
and wherein the contours are symmetrical about a longitudinal axis of the utensil;
the trailing end comprising a handle which allows a user to urge the utensil longitudinally of the body so the shell is separated from the crustacean in one pass along its spine.

37. A utensil according to claim 36 wherein, the leading edge tapers from a first narrow region at the leading tip of the utensil to a wider region terminating at said wall.

38. A utensil according to claim 37 wherein the leading end tip has a convex outer surface and a concave inner surface.

39. A utensil according to claim 38 wherein the contours include a leading edge which engage lateral portions of a shell for removal.

40. A utensil according to claim 39 wherein the recess defined by the contours is substantially U shaped or circular when viewed in cross section.

41. A utensil according to claim 40 wherein the leading tip includes a surface which includes a relief extending therefrom for deveining.

42. A utensil according to claim 41 wherein the wall formed by said contours extends a further distance along a normal to a spine of the peeler than the tip.

43. A utensil according to claim 42 wherein the longitudinal recess receives a sand vein from the crustacean body during peeling of the shell.

44. A utensil according to claim 43 wherein the winged contours are curved.

45. A utensil according to claim 44 wherein the recess in said handle extends substantially the length of the handle.

46. A utensil according to claim 45 wherein the utensil is cold formed from a metal plate.

47. A utensil according to claim 46 wherein the handle is formed by turning edges of the metal plate for at least for half the length of the handle.

48. A utensil according to claim 47 wherein the turned edges provide strengthening ribs for the handle.

49. A utensil for removing the shell from the body of a crustacean prior to consumption; the utensil comprising;
a utensil body having a leading end and a trailing end;
wherein the leading end includes a tapered leading edge tip capable of engaging the crustacean between an underside of a shell and an opposing body surface of the crustacean;
wherein the taper increases in width in the direction of the trailing end and terminates in contoured wings which define a concave recess and which co operate with the leading edge tip during removal of the shell to lift a spine region of the shell and separate lateral shell skirts from said crustacean body;
the trailing end comprising a handle which allows a user to urge the utensil longitudinally of the body so the shell is separated in one pass along the body of the crustacean.

50. A method of manufacturing a utensil for removing the shell from a crustacean; the method comprising the steps of;
introducing a plastics material into a mould having a configuration which produces a utensil which comprises;
a utensil body having a leading end and a trailing end;
wherein the leading end includes a leading edge tip capable of engaging the crustacean between an underside of a shell and opposing body surface of the crustacean;
the leading end further comprising contoured portions which co operate with the leading end tip to lift and separate said shell from said crustacean body;
the trailing end comprising a handle which allows a user to urge the utensil longitudinally of the body so the shell is able to be separated in one pass along the back of the crustacean.
